(19) United States
(12) Patent Application Publication
(10) Pub. No.: US 2015/0114197 A1
(43) Pub. Date: Apr. 30, 2015

(54) COMPOSITE BLADE MODULE AND CUTTING MEANS USING THE SAME

(71) Applicant: CHAN LI MACHINERY CO., LTD., TAOYUAN (TW)

(72) Inventor: TUNG-I TSAI, TAOYUAN (TW)

(73) Assignee: CHAN LI MACHINERY CO., LTD., TAOYUAN (TW)

(21) Appl. No.: 14/222,825

(22) Filed: Mar. 24, 2014

(30) Foreign Application Priority Data
Oct. 30, 2013 (TW) 102139353

(51) Int. Cl. B26D 1/38; B26D 1/00

(52) U.S. Cl. CPC B26D 1/385; B26D 1/0006; B26D 2001/002; B26D 2001/0066
USPC 83/592; 83/698.11

(57) ABSTRACT

The present invention provides a composite blade module and cutting means using the same. The composite blade module comprises a blade and at least one elastic layer. The elastic layers are adhered to a part of cutting edge and/or a back of the blade selectively. The composite blade module is used by the cutting means to cut an object to be cut. The elastic layers may be used as a shock absorber to absorb the collision force acting on the blade, thus reducing the probability of breaking blade, during the cutting process. Furthermore, if the blade is broken unfortunately, the broken blade is still adhered to the elastic layers, in such a way that the broken blade is prevented from either being drawn into the cutting means and then damaging the means, or being ejected and then endangering the operator, leading to safety guarantee during cutting.

### FIELD OF THE INVENTION

The present invention provides a composite blade module and cutting means using the same, particularly to a composite blade module used in a cutting means for cutting an object to be cut.

### BACKGROUND

The former cutting blade module is composed of two corresponding steel blades, each being fixed on the structure of metallic wheel body, respectively. The blades are contacted with each other to cut, thus cutting a thin object to be cut (such as paper material, fiber material or plastic material). When the blades are thicker, the requirement for hardness may be achieved, while elasticity (or referred to as toughness) is insufficient, in such a way that damage to the cutting edge or structure of the blades may be readily resulted from excess collision force when the blades are contacted with each other. Moreover, extremely loud metallic noise may be generated from strong collision between the metallic blades. Further, vibration of the cutting means is possibly induced in case of excess collision force. Alternatively, when the blades are thinner, elasticity is better, while rigidity is insufficient, in such a way that cutting result is usually not very desirable.

Furthermore, the blades are readily worn or broken in the cutting process, and thus, are necessarily changed on frequent shutdown, leading to drop in production capacity with affected efficiency. Furthermore, when the blades are broken, the fractured debris may be drawn into the means, to cause other means to be destroyed, leading to huge impact.

Further, heat generated from the cutting means in the operating process thereof may be readily conducted to the blades from the metallic wheel body, such that the blades may be deformed due to thermal expansion and contraction. Then, the problem of positioning deviation may be generated readily in the cutting process so as to affect the cutting precision.

Accordingly, the present invention provides a composite blade module with enhanced safety, in which at least one elastic layer is adhered to the surface of blades, such that not only prolonged service life of blades, but also the prevention of flying off broken blades, together with enhanced cutting precision and reduced metallic noise in the cutting process will be the objects to be achieved by the present invention desirably.

### SUMMARY OF THE INVENTION

It is one object of the present invention to provide a composite blade module and cutting means using the same, the composite blade module comprising a blade and at least one elastic layer, the elastic layer being adhered to a part of cutting edge and/or a back of the blade selectively, in such a way that when the composite blade module is used by the cutting means to cut an object to be cut, the elastic layers may be used as a shock absorber, to absorb a collision force acting on the blade, thus reducing the probability of breaking blade, and further prolonging the service life of the blade.

It is one object of the present invention to provide a composite blade module and cutting means using the same, in which an elastic layer with adhesive property is adhered to the surface of blade, in such a way that if the blade is broken unfortunately during the cutting process, the broken blade is still adhered to the elastic layer, such that the broken blade is prevented from either being drawn into the cutting means and then damaging the means, or being ejected and then endangering the operator, leading to safety guarantee during cutting.

It is one object of the present invention to provide a composite blade module and cutting means using the same, in which when the composite blade module is used by the cutting means for cutting, the collision force acting on the blades may be absorbed by an elastic layer, so as to reduce metallic noise generated during the cutting process.

It is one object of the present invention to provide a composite blade module and cutting means using the same, in which at least one elastic layer of appropriate material and appropriate thickness is adhered to the surface of blades selectively, so as to obtain a composite blade module conforming to the requirement of the cutting means for rigidity or toughness.

It is one object of the present invention to provide a composite blade module and cutting means using the same, in which when the cutting means is operated, the elastic layers may be used for isolating conduction of heat, generated from the operation of cutting means, to the blades, thereby avoiding the problem of positioning deviation of blades, and thus affected cutting precision, resulted from thermal expansion and contraction.

To achieve above objects, the present invention provides a composite blade module, provided in a cutting means, comprising: a blade; and at least one elastic layer, selectively adhered to a part of cutting edge and/or a back of the blade, wherein the exposed cutting edge of the blade is used by the cutting means to cut an object to be cut.

In one embodiment of the present invention, wherein one or more the elastic layers are adhered to the part of cutting edge and/or the back of the blade.

In one embodiment of the present invention, wherein the adjustment of thickness and the selection of material of each of the elastic layers are determined on the basis of rigidity or toughness of the composite blade module demanded by the cutting means.

In one embodiment of the present invention, wherein the elastic layer is made of soft metallic material or rubber-like material.

In one embodiment of the present invention, wherein the elastic layer is made of soft metallic material or rubber-like material.

In one embodiment of the present invention, wherein each of the elastic layers is selectively provided on the part of cutting edge and/or the back of the blade depending upon the direction of force on the blade.

The present invention another provides a cutting means, comprising: a bottom wheel, on a wheel face of which, each bottom-wheel blade is provided at constant interval; a top wheel, provided above the bottom wheel, comprising: a composite blade module, comprising a top-wheel blade and at least one elastic layer, each elastic layer being selectively adhered to a part of cutting edge and/or a back of the top-wheel blade; and a blade fixture, fixed at one side of the top wheel, used for clamping the composite blade module; and an object to be cut, transmitted between the top wheel and the bottom wheel, wherein the bottom wheel is rotated in a predetermined direction, such that a cutting edge of the bottom-wheel blade and the exposed cutting edge of the top-wheel blade are contacted with each other at an inclination angle to cut the object to be cut.

In one embodiment of the present invention, wherein the inclination angle at which the top-wheel blade and the bottom-wheel blade cut each other is adjusted by turning the top wheel.

The present invention another provides a cutting means, comprising: a rotating wheel, on a wheel face of which, there is provided with each of first composite blade modules at constant interval, each of the first composite blade module comprising a rotating-wheel blade and at least one first elastic layer, respectively, the first elastic layer being adhered to a part of cutting edge of the rotating-wheel blade, wherein a first fixing plate is provided on each of the first elastic layer, each of the first composite blade module is fixed on the wheel face of the rotating wheel via the corresponding first fixing plate; and a fixed wheel, provided at the side of the rotating wheel, on a wheel face of which, there is provided with a second composite blade module, the second composite blade module comprising a fixed-wheel blade and at least one second elastic layer, the second elastic layer being adhered to a part of cutting edge of the fixed-wheel blade, wherein a second fixing plate is provided on the second composite blade module, the second composite blade is fixed on the wheel face of the fixed wheel via the second fixing plate; and an object to be cut, transmitted between the rotating wheel and the fixed wheel, wherein the rotating wheel is rotated in a predetermined direction, such that the exposed cutting edge of the rotating-wheel blade and the exposed cutting edge of the fixed-wheel blade are contacted with each other at a horizontal angle to cut the object to be cut.

In one embodiment of the present invention, wherein the second composite blade module further comprises at least one third elastic layer, which is adhered between a back of the fixed-wheel blade and the wheel face of the fixed wheel

In one embodiment of the present invention, wherein the fixed-wheel blade or the rotating-wheel blade is selectively provided with a linear cutting edge or a zigzag cutting edge.

### BRIEF DESCRIPTION OF DRAWINGS

FIG. 1(A) is a structural diagram of a composite blade module according to one embodiment of the present invention.

FIG. 1(B) is a structural diagram of a composite blade module according to a further embodiment of the present invention.

FIG. 1(C) is a structural diagram of a composite blade module according to a further embodiment of the present invention.

FIG. 2 is a structural diagram of a cutting means using a composite blade module according to one embodiment of the present invention.

FIG. 3 is an enlarged structural diagram of the composite blade module illustrated in FIG. 2.

FIG. 4 is a structural diagram of a cutting means using a composite blade module according to a further embodiment of the present invention.

FIG. 5 is a perspective exploded structural diagram of a rotating wheel having first composite blade modules of the present invention.

FIG. 5(A) is an assembled diagram of partial structure of the rotating wheel having first composite blade modules of the present invention.

FIG. 6 is a perspective exploded structural diagram of a fixed wheel having a second composite blade module of the present invention.

FIG. 6(A) is an assembled diagram of partial structure of the fixed wheel having the second composite blade module of the present invention.

### DETAILED DESCRIPTION

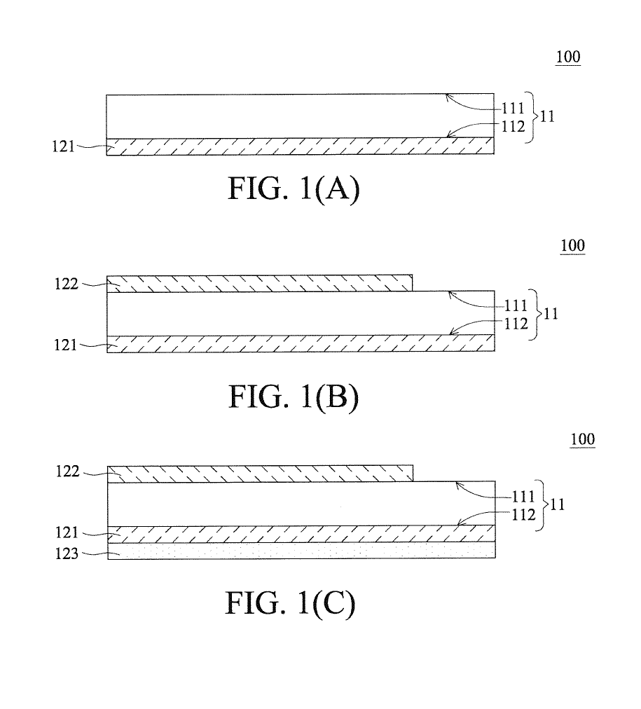

Referring to FIGS. 1(A), 1(B) and 1(C), there are shown structural diagrams of composite blade modules according to embodiments of the present invention, respectively. A composite blade module 100 of the present invention is provided in a cutting means, and composed of a blade 11 in cooperation with at least one elastic layer 121, 122, 123 of an identical material or different materials. In this invention, one or more elastic layers 121, 122 and/or 123 may be selectively adhered to appropriate surfaces of the blade 11 (such as, a part of cutting edge 111 and/or a back 112) according to the direction of force on and variation in structure of the blade 11. Moreover, in the embodiments of the present invention, each elastic layer 121, 122, 123 may be adhered to the surface of the blade 11 via an adhesive material (such as, glue).

As illustrated by the embodiment in FIG. 1(A), the elastic layer 121 may be selectively adhered to the back 112 of the blade 11. Further, as illustrated by the embodiment in FIG. 1(B), a part of the cutting edge 111 of the blade 11 may be also selectively adhered with an elastic layer 122, and the top and bottom surfaces of the blade 11 may be then enclosed by the elastic layers 121, 122. Alternatively, as illustrated in FIG. 1(C), not only one elastic layer 121, but also the other elastic layer 123 may be adhered to the back 112 of the blade 11, whereby multiple elastic layers 121, 123 may be stacked on the back 112 of the blade 11. In one embodiment of the present invention, naturally, the cutting edge 111 of the blade 11 may be adhered thereon with multiple elastic layers 122. Thus, the exposed cutting edge 111 of the blade 11 in the composite blade module 100 may be used by the cutting means to cut a transmitted thin object to be cut (such as, paper material, fiber material or plastic material).

In this invention, the elastic layers 121, 122 and/or 123 of appropriate material and appropriate thickness may be selected to be adhered to the surface of the blade 11 according to the requirement of the cutting means for rigidity or toughness of the composite blade module 100. If a blade module 100 of greater rigidity is required for the cutting means, but the blade 11 is too thin unable to achieve the requirement for rigidity, the blade 11 may be adhered to the surface thereof with at least one elastic layer 121, 122 and/or 123 made of soft metallic material (such as, aluminum or stainless steel) of appropriate thickness, so as to enhance rigidity of the blade module 100, further improving the cutting effect when the object to be cut is cut. Alternatively, if a blade module 100 of greater toughness is required for the cutting means, but the blade 11 is thick with greater hardness, the blade 11 may be adhered to the surface thereof with at least one elastic layer 121, 122 and/or 123 made of rubber-like material (such as, rubber strips, double-sided tapes, foam) of appropriate thickness, so as to provide significant variation in toughness for the blade module 100, thus reducing the probability of breaking blade 11 during the cutting process. Thereby, a composite blade module 100 conforming to the rigidity or toughness requirement of the cutting means may be obtained by adhering the elastic layers 121, 122 and/or 123 of appropriate material and appropriate thickness, selectively, to the surface of the blade 11.

When the composite blade module 100 is used by the cutting means to cut the object to be cut, the elastic layers 121, 122 and/or 123 may be used as a shock absorber, to absorb the collision force acting on the blade 11, thus reducing the probability of breaking blade 11, and further prolonging the service life of the blade 11. If the blade 11 is broken unfortunately due to a huge collision force during the cutting process, the broken blade 11 is still adhered to the elastic layers 121, 122 and/or 123 of adhesive property, in such a way that the broken blade 11 is prevented from either being drawn into the cutting means and then damaging the means, or being ejected and then endangering the operator, leading to safety guarantee during cutting. In addition, metallic noise generated during the cutting process may be reduced effectively, due to the fact that the elastic layers 121, 122 and/or 123 may be used for the absorption of collision force acting on the blade 11.

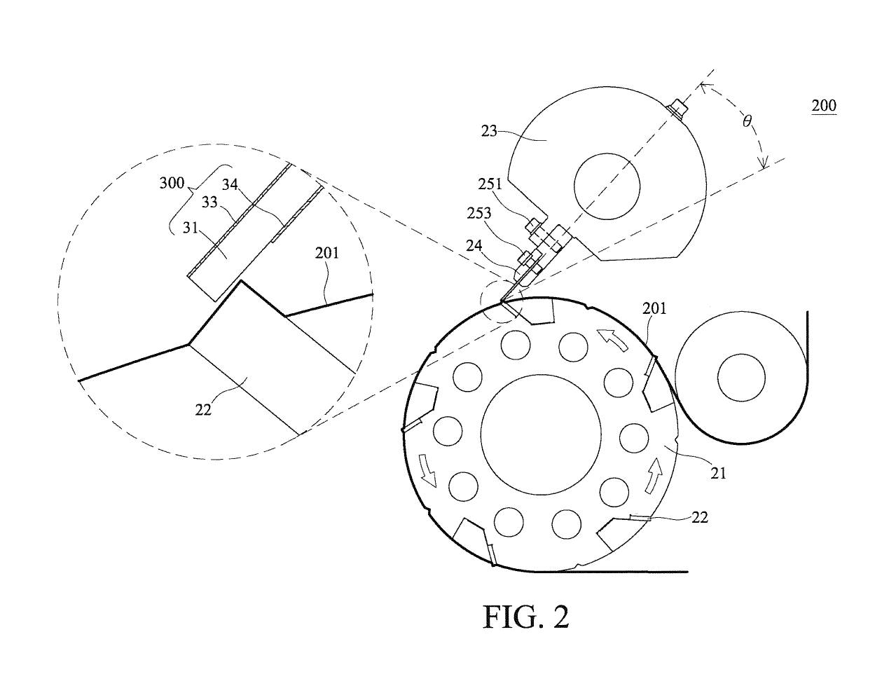

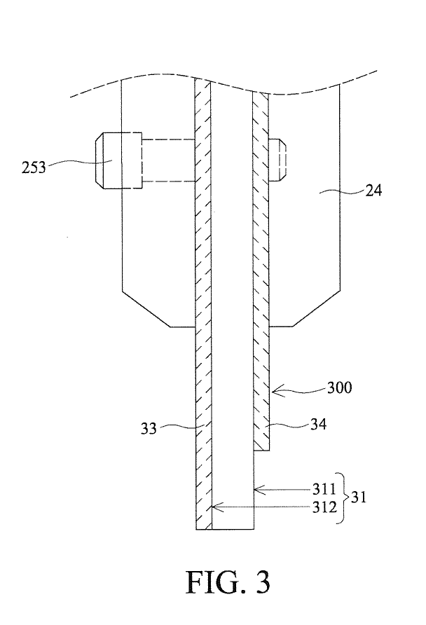

Referring to FIGS. 2 and 3, there are shown a structural diagram of a cutting means using a composite blade module according to one embodiment of the present invention, and an enlarged structural diagram of the composite blade module. A composite blade module 300 of this embodiment may be used in a cutting means 200 of a paper folding machine.

The cutting means 200 comprises a bottom wheel 21 and a top wheel 23, the top wheel 23 being provided above the bottom wheel 21. Each of bottom-wheel blades 22 is provided on the wheel face of the bottom wheel 21 at constant interval. The top wheel 23 comprises the composite blade module 300 and a blade fixture 24. The blade fixture 24 is fixed at one side of the top wheel 23, and used for clamping the composite blade module 300. The composite blade module 300 comprises a top-wheel blade 31 and at least one elastic layer 33, 34. Wherein the elastic layer 33 is provided on a back 312 of the top-wheel blade 31, while the elastic layer 34 is provided on a part of cutting edge 311 of the top-wheel blade 31. In addition, the blade fixture 24 may be fixed at one side of the top wheel 23 via a first fixing element 251, while the top-wheel blade 31 may be fixed in the blade fixture 24 via a second fixing element 253.

Further, an object to be cut 201 is further transmitted in the cutting means 200. This object to be cut 201 is adsorbed on the wheel face of the bottom wheel 21, so as to be transmitted between the bottom wheel 21 and the top wheel 23. The blades 22, 31 are used by the bottom wheel 21 and the top wheel 23, correspondingly, to cut the object to be cut 201 adsorbed on the bottom wheel 21 in a shearing manner. When the cutting means 200 is operated, the bottom wheel 21 is rotated in a predetermined direction (such as, counterclockwise direction), while the top wheel 23 is remained at a standstill. Afterwards, one of the bottom-wheel blades 22 may be rotated to the side of the top-wheel blade 31 of the composite blade module 300, such that the cutting edge of the bottom-wheel blade 22 and the exposed cutting edge 311 of the top-wheel blade 31 may be collided with each other at an inclination angle θ to cut the object to be cut 201 in the shearing manner.

Furthermore, the inclination angle θ at which the top-wheel blade 31 and the bottom-wheel blade 22 cut each other may be adjusted by turning the top wheel 23 in the cutting means 200. If the inclination angle θ is adjusted to be a larger angle, the two blades 31, 32 are capable of cutting off the object to be cut successfully, while larger colliding impact force may be sustained by the top-wheel blade 31, resulting in liability to wear, and even breakage of the top-wheel blade 31. On the contrary, when the inclination angle θ is adjusted to be a smaller angle to reduce colliding impact force, the cutting effect is, nevertheless, so poor that the object to be cut 201 is not easy to be cut off by the two blades 31, 32.

To solve the problem of wearing and breaking the top-wheel blade 31, readily resulted from cutting between the two blades 31, 32 at a larger inclination angle θ, the elastic layers 33, 34 are adhered to a part of cutting edge 311 and a back 312 of the top-wheel blade 31, respectively. These elastic layers 33, 34 may be used as a shock absorber, to absorb the colliding impact force exerted by the bottom-wheel blade 22 on the top-wheel blade 31, so as to reduce the probability of breakage of the top-wheel blade 31, further prolonging the service life of the top-wheel blade 31. Furthermore, even though the top-wheel blade 31 is broken due to collide from the bottom-wheel blade 22, the broken top-wheel blade 31 is still adhered to the elastic layers 33, 34, thereby avoiding danger caused by flying off broken top-wheel blade 31.

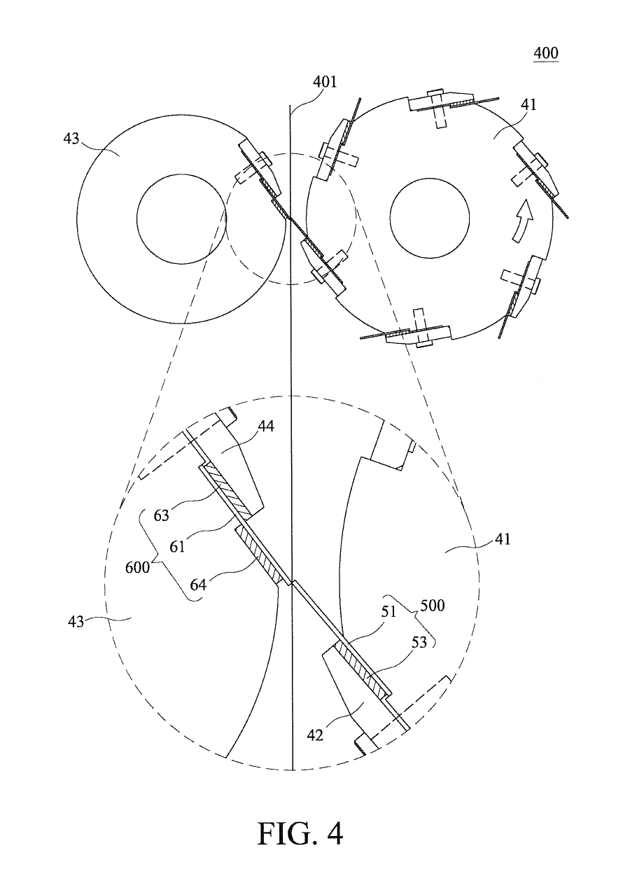

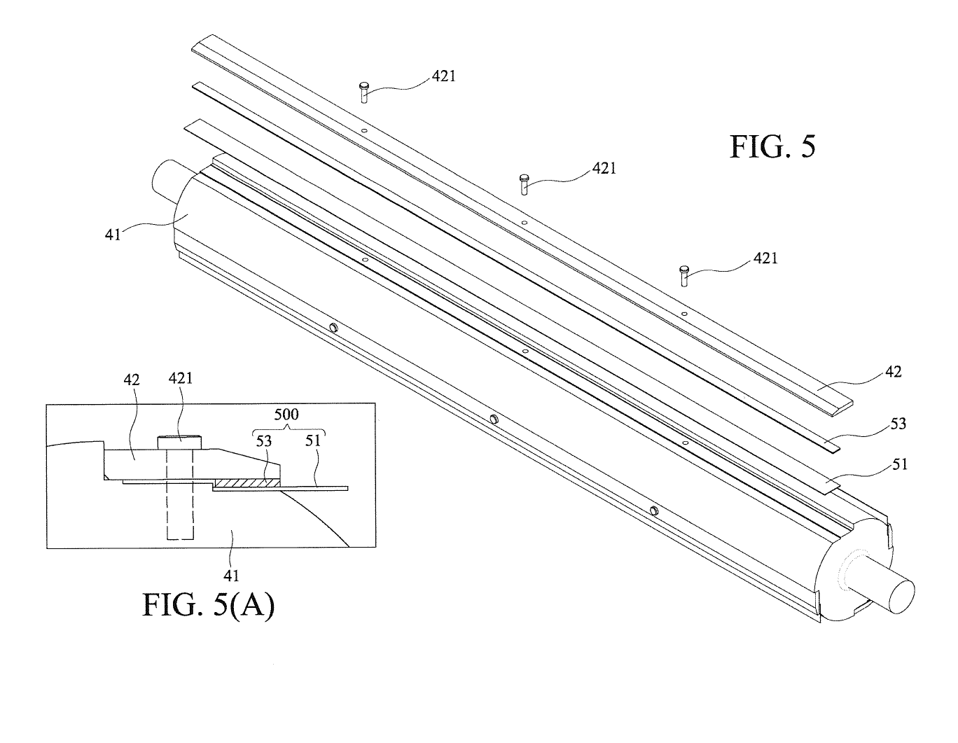

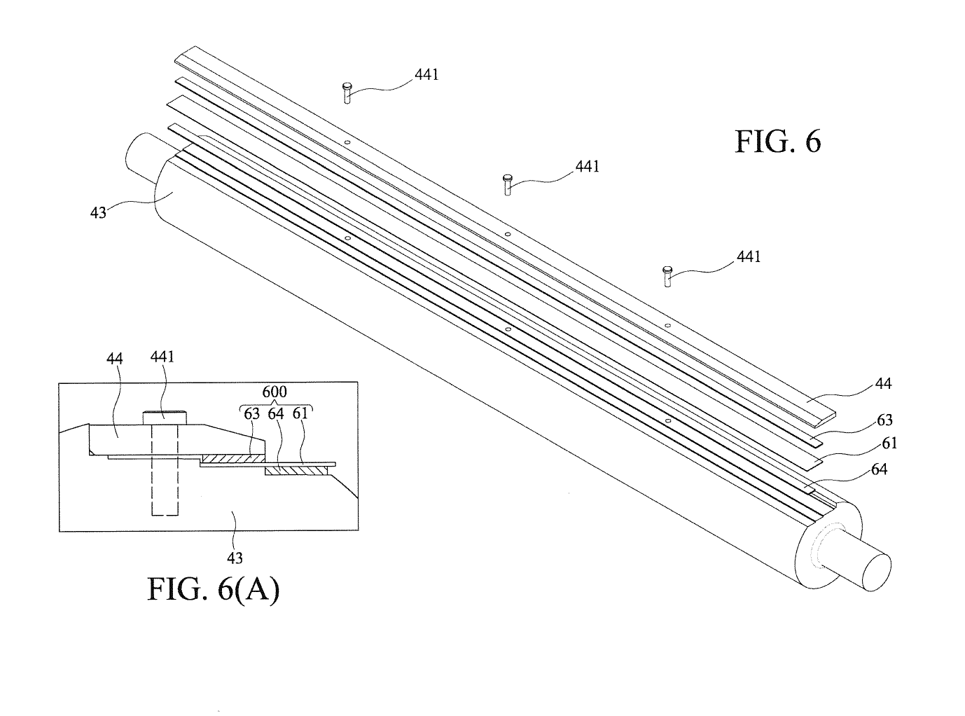

Referring to FIG. 4, there is shown a structural diagram of a cutting means using a composite blade module according to another embodiment of the present invention, as well as referring to FIGS. 5 and 5(A), there are shown a perspective exploded structural diagram and an assembled diagram of partial structure, respectively, of a rotating wheel having first composite blade modules of the present invention, and FIGS. 6 and 6 (A) are a perspective exploded structural diagram and an assembled diagram of partial structure, respectively, of a fixed wheel having a second composite blade module. The composite blade modules 500, 600 of this embodiment may be used in a cutting means 400 of a roller-type processing machinery. The cutting means 400 comprises a rotating wheel 41 and a fixed wheel 43, the fixed wheel 43 being provided at the side of the rotating wheel 41. A provides with B

In this case, each of the first composite blade modules 500 is provided on the wheel face of the rotating wheel 41 at constant interval. The first composite blade module 500 comprises a rotating-wheel blade 51 and at least one first elastic layer 53, the first elastic layer 53 being adhered to a part of cutting edge of the rotating-wheel blade 51. In addition, each first elastic layer 53 is provided thereon, respectively, with a first fixing plate 42, via which each first composite blade module 500 may be fixed on the wheel face of the rotating wheel 41. Furthermore, each first fixing plate 42 may be locked on the wheel face of the rotating wheel 41 by at least one correspondingly first fixing element 421, respectively.

Additionally, the wheel face of the fixed wheel 43 is provided thereon with one second composite blade module 600. The second composite blade module 600 comprises a fixed-wheel blade 61 and at least one second elastic layer 63. The second elastic layer 63 is adhered to a part of cutting edge of the fixed-wheel blade 61. In addition, the second elastic layer 63 is provided thereon with a second fixing plate 44, via which the second composite blade module 600 may be fixed on the wheel face of the fixed wheel 43. Furthermore, the second fixing plate 44 may be locked on the fixed wheel 43 by at least one second fixing element 441.

An object to be cut 401 is further transmitted in the cutting means 400. This object to be cut 401 is transmitted between the rotating wheel 41 and the fixed wheel 43. When the cutting means 400 is operated, the rotating wheel 41 is rotated in a predetermined direction (such as, counterclockwise direction), while the fixed wheel 43 is remained at a standstill. Afterwards, the rotating-wheel blade 51 of one of the first composite blade modules 500 may be rotated to the side of the fixed-wheel blade 61 of the second composite blade module 600, such that the exposed cutting edge of the rotating-wheel blade 51 and the exposed cutting edge of the fixed-wheel blade 61 may be collided with each other at a horizontal angle to cut the object to be cut 410.

The rotating-wheel blade 51 is protruded over a long distance from the wheel face of the rotating wheel 41. When the rotating-wheel blade 51 and the fixed-wheel blade 61 are collided with each other, the main body of the rotating-wheel blade 51 may be deformed significantly due to this structure of blade with larger protruding distance, so as to absorb larger colliding impact force, resulting in hardly breaking the rotating-wheel blade 51 during the cutting process. In addition, when the rotating-wheel blade 51 and the fixed-wheel blade 61 are collided with each other, the rear end of the rotating-wheel blade 51 and the first fixing plate 42 may be pressed together due to leverage generated from the acting force at the front end thereof. Thus, the first elastic layer 53 between the rotating-wheel blade 51 and the first fixing plate 42 may be used as a shock absorber, so as to absorb the pressing force. Subsequently, after the collision between the rotating-wheel blade 51 and the fixed-wheel blade 61 is finished, resilience generated from the rotating-wheel blade 51 may be transmitted to the rear end from the front end thereof, and may be similarly absorbed by the first elastic layer 53. In this embodiment, the first fixing plate 42 is prevented from being loosed or damaged by impact from pressing force or resilience, due to the fact that impact force is absorbed by the first elastic layer 53.

Compared with the rotating-wheel blade 51, the fixed-wheel blade 61 is protruded over a shorter distance from the wheel face of the fixed wheel 43. When the rotating-wheel blade 51 and the fixed-wheel blade 61 are contacted with each other, the front end of the fixed-wheel blade 61 and the wheel face of the fixed wheel 43 may be pressed together directly during the cutting process, readily resulting in damage to the wheel face of the fixed wheel 43 or breakage of front end of the rotating-wheel blade 61, due to this structure of blade with shorter protruding distance. In one embodiment of the present invention, therefore, a third elastic layer 64 is further adhered between the back of the fixed-wheel blade 61 and the wheel face of the fixed wheel 43. The third elastic layer 64 may be used as a shock absorber between the fixed-wheel blade 61 and the wheel face of the fixed wheel 43, so as to avoid direct press between the front end of the fixed-wheel blade 61 and the wheel face of the fixed wheel 43 during the cutting process. Furthermore, the second elastic layer 63 between the fixed-wheel blade 61 and the second fixing plate 44, the same as aforementioned first elastic layer 53, is also capable of absorbing pressing force or resilience, when the rotating-wheel blade 51 and the fixed-wheel blade 61 are collided with each other, or this collision is finished. Then, the second fixing plate 44 is prevented from being loosed or damaged by impact from pressing force or resilience.

Similarly, even though the rotating-wheel blade 51 or the fixed-wheel blade 61 is broken due to collision in the cutting process, the broken rotating-wheel blade 51 or fixed-wheel blade 61 may be still adhered to the elastic layers 53. 64 and/or 64, thereby guaranteeing safety during the operation of cutting means 400. In addition, when the cutting means 400 is operated, the elastic layers 53, 63, 64 may be used for isolating conduction of heat, generated from the operation of cutting means 400, to the rotating-wheel blade 51 and the fixed-wheel blade 61. Thereby, the problem of positioning deviation of rotating-wheel blade 51 and fixed-wheel blade 61, and thus affected cutting precision, resulted from thermal expansion and contraction, may be avoided.

In one embodiment of the present invention, a variety of cutting effects on the object to be cut 401 may be also obtained through changing different types of blades 51, 61 of the cutting means 400. If the blades 51, 61 having linear cutting edges are used for cutting the object to be cut 401, a linear cutout may be formed on the object to be cut 401, so as to cut off the object to be cut 401 entirely. Alternatively, if the blade 61/51 having a zigzag cutting edge is used for cutting the object to be cut 401, a perforated cutout may be formed on the object to be cut 401, such as, the perforated cutout used for tearing being formed on toilet rolls.

Naturally, there are still various embodiments for the present invention. It should be understood that various changes and alterations could be made to the present invention by those skilled in the art without departing from the spirit and scope of the invention, and included within the scope of the appended claims.

1. A composite blade module, provided in a cutting means, comprising:
a blade; and
at least one elastic layer, selectively adhered to a part of cutting edge and/or a back of said blade, wherein the exposed cutting edge of said blade is used by said cutting means to cut an object to be cut.

2. The composite blade module according to claim 1, wherein one or more said elastic layers are adhered to the part of cutting edge and/or the back of said blade.

3. The composite blade module according to claim 1, wherein the adjustment of thickness and the selection of material of each of said elastic layers are determined on the basis of rigidity or toughness of said composite blade module demanded by said cutting means.

4. The composite blade module according to claim 1, wherein said elastic layer is made of soft metallic material or rubber-like material.

5. The composite blade module according to claim 1, wherein each of said elastic layers is selectively provided on the part of cutting edge and/or the back of said blade depending upon the direction of force on said blade.

6. A cutting means, comprising:
a bottom wheel, on a wheel face of which, each bottom-wheel blade is provided at constant interval;
a top wheel, provided above said bottom wheel, comprising:
a composite blade module, comprising a top-wheel blade and at least one elastic layer, each elastic layer being selectively adhered to a part of cutting edge and/or a back of said top-wheel blade; and
a blade fixture, fixed at one side of said top wheel, used for clamping said composite blade module; and
an object to be cut, transmitted between said top wheel and said bottom wheel, wherein said bottom wheel is rotated in a predetermined direction, such that a cutting edge of said bottom-wheel blade and the exposed cutting edge of said top-wheel blade are contacted with each other at an inclination angle to cut said object to be cut.

7. The cutting means according to claim 6, wherein said inclination angle at which said top-wheel blade and said bottom-wheel blade cut each other is adjusted by turning said top wheel.

8. A cutting means, comprising:
a rotating wheel, on a wheel face of which, there is provided with each of first composite blade modules at constant interval, each of said first composite blade module comprising a rotating-wheel blade and at least one first elastic layer, respectively, said first elastic layer being adhered to a part of cutting edge of said rotating-wheel blade, wherein a first fixing plate is provided on each of said first elastic layer, each of said first composite blade module is fixed on the wheel face of said rotating wheel via said corresponding first fixing plate; and
a fixed wheel, provided at the side of said rotating wheel, on a wheel face of which, there is provided with a second composite blade module, said second composite blade module comprising a fixed-wheel blade and at least one second elastic layer, said second elastic layer being adhered to a part of cutting edge of said fixed-wheel blade, wherein a second fixing plate is provided on said second composite blade module, said second composite blade is fixed on the wheel face of said fixed wheel via said second fixing plate; and
an object to be cut, transmitted between said rotating wheel and said fixed wheel, wherein said rotating wheel is rotated in a predetermined direction, such that the exposed cutting edge of said rotating-wheel blade and the exposed cutting edge of said fixed-wheel blade are contacted with each other at a horizontal angle to cut said object to be cut.

9. The cutting means according to claim 8, wherein said second composite blade module further comprises at least one third elastic layer, which is adhered between a back of said fixed-wheel blade and the wheel face of said fixed wheel.

10. The cutting means according to claim 8, wherein said fixed-wheel blade or said rotating-wheel blade is selectively provided with a linear cutting edge or a zigzag cutting edge.
